(19) United States
(12) Patent Application Publication
(10) Pub. No.: US 2025/0164427 A1
(43) Pub. Date: May 22, 2025

(54) DATA PROCESSING METHOD AND SYSTEM

(71) Applicant: Beijing Real Material Data Technology Development Co., Ltd., Beijing (CN)

(72) Inventors: Xiaodong XIANG, Danville, CA (US); Shaomeng XU, Kunming (CN)

(73) Assignee: Beijing Real Material Data Technology Development Co., Ltd., Beijing (CN)

(21) Appl. No.: 18/955,774

(22) Filed: Nov. 21, 2024

(30) Foreign Application Priority Data
Nov. 21, 2023 (CN) 2023115603867

(51) Int. Cl. G01N 27/04

(52) U.S. Cl. CPC G01N 27/045; G01N 27/041

(57) ABSTRACT

A method and a system for determining attribute data that effectively describes a target object are provided. The method includes: obtaining a descriptor set that describes attributes of a target object, where the descriptor set includes K descriptors; performing a plurality of dimensionality reduction iterations on the descriptor set to reduce a quantity of descriptors in the descriptor set, until the plurality of dimensionality reduction iterations meet preset stop information; determining, from descriptors obtained by the plurality of dimensionality reduction iterations, descriptors whose occurrence frequencies meet a preset condition as core descriptors; and outputting the core descriptors and N as attribute data to improve validity and reliability of the attribute data used to describe the target object.

### RELATED APPLICATIONS

This application claims the benefit of priority of Chinese application number 2023115603867, filed on Nov. 21, 2023, which claims the benefit of priority of U.S. provisional application No. 63/426,814, filed on Nov. 21, 2022, and the contents of the foregoing documents are incorporated herein by reference in entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates to the field of artificial intelligence technologies, and in particular, to a method and system for determining attribute data that effectively describes a target object.

### BACKGROUND

In the related art, a training system may obtain a neural network model through training, and a prediction system may predict a target descriptor value of a target object based on the neural network model.

In the training system, input data used for training the neural network model is sample data, and the sample data is a descriptor set including descriptors in full.

However, the inventors of the present disclosure find that when the training system trains the neural network model by using a full set of descriptors, and especially when a quantity of descriptors in the full set is large, a training time of the training system is long and efficiency is low. In addition, the full set of descriptors may contribute very little to the training but reduce efficiency of training, that is, absence of this part of descriptors does not have great impact on a training effect. Therefore, how to determine a relative quantity of valid descriptors from the full set of descriptors, that is, how to determine attribute data that effectively describes the target object, has become a problem that needs to be resolved urgently.

It should be noted that content of the related art is only information known to the inventors personally, and neither represents that the information has entered the public domain before the filing date of the present disclosure, nor represents that it can become the prior art of the present disclosure.

### SUMMARY

The present disclosure provides a method and system for determining attribute data that effectively describes a target object, to avoid the foregoing technical problem.

In a first aspect, the present disclosure provides a method for determining attribute data that effectively describes a target object, including: obtaining a descriptor set describing attributes of a target object, where the descriptor set includes K descriptors; performing a plurality of dimensionality reduction iterations on the descriptor set to reduce a quantity of descriptors in the descriptor set, until the plurality of dimensionality reduction iterations meet preset stop information, where the preset stop information includes a valid quantity value N that enables accuracy of the plurality of dimensionality reduction iterations to reach a first preset value while the quantity of descriptors in the descriptor set remains approximately unchanged, the accuracy is used to represent consistency between a predicted value and a real value of a preset target model, and K and N are both integers greater than 1; determining, from descriptors obtained by the plurality of dimensionality reduction iterations, descriptors whose occurrence frequencies meet a preset condition as core descriptors; and outputting the core descriptors and N as attribute data.

In a second aspect, the present disclosure provides a system for determining attribute data that effectively describes a target object, including: at least one memory, where the memory includes at least one set of instructions to push information; and at least one processor, communicating with the at least one memory, where during operation, the at least one processor executes the at least one set of instructions to cause the system to at least: obtain a descriptor set describing attributes of a target object, where the descriptor set includes K descriptors, perform a plurality of dimensionality reduction iterations on the descriptor set to reduce a quantity of descriptors in the descriptor set, until the plurality of dimensionality reduction iterations meet preset stop information, where the preset stop information includes a valid quantity value N that enables accuracy of the plurality of dimensionality reduction iterations to reach a first preset value while the quantity of descriptors in the descriptor set remains approximately unchanged, the accuracy is used to represent consistency between a predicted value and a real value of a preset target model, and K and N are both integers greater than 1, determine, from descriptors obtained by the plurality of dimensionality reduction iterations, descriptors whose occurrence frequencies meet a preset condition as core descriptors, and output the core descriptors and N as attribute data.

The present disclosure provides a method and system for determining attribute data that effectively describes a target object. The method includes: obtaining a descriptor set that describes attributes of a target object, where the descriptor set includes K descriptors; performing a plurality of dimensionality reduction iterations on the descriptor set to reduce a quantity of descriptors in the descriptor set, until the plurality of dimensionality reduction iterations meet preset stop information, where the preset stop information includes a valid quantity value N that enables accuracy of the plurality of dimensionality reduction iterations to reach a first preset value while the quantity of descriptors in the descriptor set remains approximately unchanged, the accuracy is used to represent consistency between a predicted value and a real value of a preset target model, and K and N are both integers greater than 1; determining, from descriptors obtained by the plurality of dimensionality reduction iterations, descriptors whose occurrence frequencies meet a preset condition as core descriptors; and outputting the core descriptors and N as attribute data. In the embodiments, by performing dimensionality reduction iterations on the descriptor set, a determining system may obtain a valid descriptor quantity (that is, N) that enables the target model to have relatively good prediction performance while the quantity of descriptors in the descriptor set remains basically unchanged. In addition, the determining system may obtain descriptors (that is, the core descriptors) with relatively high occurrence frequencies and great impact on the prediction performance of the target model by collecting statistics of the occurrence frequencies of the descriptors participating in the dimensionality reduction iterations. Correspondingly, the determining system may use N and the core descriptors as the attribute data of the target object to improve validity and reliability of the attribute data used to describe the target object.

### BRIEF DESCRIPTION OF THE DRAWINGS

To describe the technical solutions in the embodiments of this disclosure more clearly, the following briefly describes the accompanying drawings required for describing the embodiments. Apparently, the accompanying drawings in the following description show merely some exemplary embodiments of this disclosure, and a person of ordinary skill in the art may still derive other drawings from these accompanying drawings without creative efforts.

FIG. 1 is a schematic diagram of an application scenario of a method according to some exemplary embodiments of the present disclosure;

FIG. 2 is a schematic diagram of a method for determining attribute data that effectively describes a target object according to some exemplary embodiments of the present disclosure;

FIG. 3 is a schematic diagram of a method for performing a plurality of dimensionality reduction iterations on a descriptor set by using a genetic algorithm, to reduce a quantity of descriptors in the descriptor set, until the plurality of dimensionality reduction iterations meet preset stop information according to some exemplary embodiments of the present disclosure;

FIG. 4 is a schematic diagram of a principle of a genetic algorithm according to some exemplary embodiments of the present disclosure;

FIG. 5 is a schematic diagram of an effect of a genetic algorithm according to some exemplary embodiments of the present disclosure; and

FIG. 6 is a diagram of a hardware structure of an electronic device according to some exemplary embodiments of the present disclosure.

### DETAILED DESCRIPTION

Exemplary embodiments will be described in detail herein, with examples illustrated in the accompanying drawings. In the following description, when referring to the drawings, the same numbers in different drawings indicate the same or similar elements, unless otherwise noted. The embodiments described in the following exemplary embodiments do not represent all possible embodiments consistent with this disclosure. Instead, they are merely examples of devices and methods consistent with some aspects of the present disclosure as detailed in the appended claims.

It should be understood that in the embodiments of this disclosure, the terms “comprising” and “having,” as well as any variations thereof, are intended to cover inclusive but not exclusive inclusion. For example, a product or device that includes a series of components is not necessarily limited to those components explicitly listed, but may include other components not explicitly listed or components inherent to those products or devices.

In the embodiments of this disclosure, the term “and/or” describes an associative relationship between associated objects, indicating three possible relationships. For example, “A and/or B” can represent: A alone, both A and B, or B alone. The character “/” generally indicates an “or” relationship between the associated objects.

The term “multiple” in this disclosure refers to two or more, and other quantifiers are used in a similar manner.

The terms “first,” “second,” “third,” and so on are used to distinguish similar or related objects or entities and do not necessarily imply a specific order or sequence, unless otherwise indicated. It should be understood that these terms can be used interchangeably where appropriate, for example, in a sequence other than that illustrated or described in the embodiments of this disclosure.

The terms “unit/module” used in this disclosure refer to any known or later-developed hardware, software, firmware, artificial intelligence, fuzzy logic, or a combination of hardware and/or software code capable of performing functions associated with that element.

To help a reader understand the present disclosure, at least some of the terms used in the present disclosure are described as follows:

A descriptor is information describing a target object. For example, in a case where the target object is a target material, the descriptor may be information for describing properties of the target material, such as information for describing conductivity of the target material; in a case where the target object is a target speech, the descriptor may be an intent and/or volume or the like for describing the target speech; in a case where the target object is a target text, the descriptor may be characters or the like for describing the target text; or in a case where the target object is a target image, the descriptor may be a texture feature, a color feature, a pixel feature, a position feature, or the like for describing the target image.

A target descriptor value is a predicted value corresponding to a target descriptor. For example, in a case where the target object is a target material, the target descriptor value may be understood as a predicted value for predicting performance of the target material. For example, the predicted value may be conductivity or the like, which is not exhaustively illustrated herein.

A neural network (Neural Network, NN) is a complex network system formed by a large quantity of simple processing units (which may also be referred to as neurons) that are widely interconnected. It reflects many basic characteristics of human brain functions and is a highly complex nonlinear dynamic learning system. Neural networks include an artificial neural network (Artificial Neural Network, ANN) and a convolutional neural network (Convolutional Neural Network, CNN).

The ANN refers to a complex network structure formed by a large quantity of interconnected neurons. The ANN is a kind of abstraction, simplification, and simulation of an organizational structure and operation mechanism of a human brain. The ANN may be classified into a multi-layer ANN and a single-layer ANN. Each layer includes several neurons. The neurons are connected by directed arcs with variable weights. The network repeatedly learns and trains known information and gradually adjusts and changes weights of neuron connections to achieve an objective of processing information and simulating an input-output relationship.

The CNN is a type of feedforward neural network (Feedforward Neural Network) that includes convolutional computing and has a deep structure. It is one of representative algorithms for deep learning (deep learning). The CNN is capable of representation learning (representation learning) and capable of performing shift-invariant classification (shift-invariant classification) on input information based on a hierarchical structure of the CNN. Therefore, the CNN is also referred to as a “shift-invariant artificial neural network (Shift-Invariant Artificial Neural Network, SIANN)”.

In the related art, a prediction system may predict a target descriptor value based on a pre-trained neural network model, and the neural network model may be obtained by the prediction system through training or by other systems (such as a training system) through training. This is not limited herein.

For example, using the neural network model obtained by the training system through training as an example, the pre-trained neural network model is obtained by the training system through training based on sample data, and the sample data may be sample descriptors. In other words, at a training stage of the neural network model, the training system inputs the sample descriptors into an initial network model for single-level inference to predict the sample data based on the initial network model, and outputs a prediction result (that is, a predicted target descriptor value). The prediction system compares the prediction result with a pre-marked real result (that is, a real target descriptor value) to obtain a comparison result, and iteratively updates parameters of the initial network model based on the comparison result, thereby obtaining a trained neural network model.

Correspondingly, the training system may transmit the trained neural network model to the prediction system, or the prediction system may invoke the trained neural network model from the training system in presence of a prediction requirement, to perform prediction based on the trained neural network model. For example, at an application stage, the prediction system inputs prediction data that needs to be predicted into the trained neural network model and outputs the prediction result.

From a perspective of an amount of sample data used to train the neural network model, the amount of sample data is a full amount of sample data, that is, the sample descriptors are a full set of descriptors, that is, the training system trains the neural network model based on the obtained full set of sample descriptors.

However, when the training system trains the neural network model by using the full set of sample descriptors, and especially when a quantity of sample descriptors in the full set is large, a training time of the training system is long and efficiency is low. In addition, the full set of sample descriptors may contribute very little to the training but reduce efficiency of training, that is, absence of this part of sample descriptors does not have great impact on a training effect. Therefore, how to determine a relative quantity of valid descriptors from the full set of sample descriptors, that is, how to determine attribute data that effectively describes the target object, has become a problem that needs to be resolved urgently.

It should be noted that content of the related art is only information known to the inventors personally, and neither represents that the information has entered the public domain before the filing date of the present disclosure, nor represents that it can become the prior art of the present disclosure.

To avoid at least one of the foregoing problems, the present disclosure provides a technical conception developed through creative efforts: A determining apparatus performs a plurality of dimensionality reduction iterations on a descriptor set obtained for describing attributes of a target object, to reduce a quantity of descriptors in the descriptor set, until attribute data that does not affect prediction performance of a target model (the prediction performance of the target model remains basically stable) while keeping the quantity of descriptors basically stable is obtained.

Before an implementation principle of a method for determining attribute data that effectively describes a target object in the present disclosure is described, an application scenario of the method for determining attribute data that effectively describes a target object in the present disclosure is first described exemplarily to deepen the reader's understanding of the method for determining attribute data that effectively describes a target object in the present disclosure.

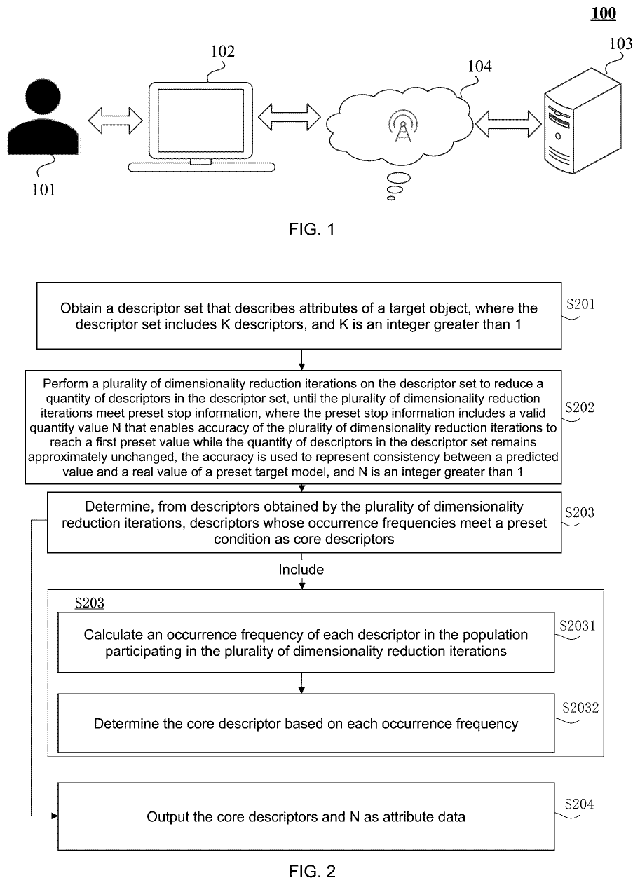

FIG. 1 is a schematic diagram of an application scenario of a method for determining attribute data that effectively describes a target object according to some exemplary embodiments of the present disclosure. The method for determining attribute data that effectively describes a target object in the present disclosure may be applied to a system 100 shown in FIG. 1. As shown in FIG. 1, the system 100 may include a target user 101, a client 102, a server 103, and a network 104.

The target user 101 may be a user who triggers determining of attribute data that effectively describes a target object. The target user 101 may determine the attribute data on the client 102.

The client 102 may be a device that determines, in response to the target user 102, the attribute data that effectively describes the target object. In other words, the method for determining attribute data that effectively describes a target object in the present disclosure may be performed on the client 102. In this case, the client 102 may store data or instructions for performing the method for determining attribute data that effectively describes a target object as described in this disclosure, and may execute or may be configured to execute the data or instructions. In some exemplary embodiments, the client 102 may include a hardware device with a data information processing function and a necessary program required to drive the hardware device to work.

As shown in FIG. 1, the client 102 may be communicatively connected to the server 103. The server 103 may be communicatively connected to one client 102, or may be communicatively connected to a plurality of clients 102. In some exemplary embodiments, the client 102 may interact with the server 103 through the network 104 to receive or send messages or the like.

In some exemplary embodiments, the client 102 may include a mobile device, a tablet computer, a notebook computer, a built-in device in a motor vehicle, or the like, or any combination thereof. In some exemplary embodiments, the mobile device may include a smart home device, a smart mobile device, a virtual reality device, an augmented reality device, or the like, or any combination thereof. In some exemplary embodiments, the smart home device may include a smart television, a desktop computer, or the like, or any combination thereof. In some exemplary embodiments, the smart mobile device may include a smartphone, a personal digital assistant, a game console, a navigation device, or the like, or any combination thereof. In some exemplary embodiments, the built-in device in the motor vehicle may include a vehicle-mounted computer, a vehicle-mounted television, or the like. In some exemplary embodiments, the client 102 may include a text capture device configured to capture search terms.

In some exemplary embodiments, one or more applications (Application, APP) may be installed on the client 102. The APP can provide the target user 101 with a capability and an interface to interact with the outside world through the network 104. The APP includes but is not limited to a web browser APP program, a search APP program, a chat APP program, a shopping APP program, a video APP program, a financial management APP program, an instant messaging tool, an e-mail client, social platform software, or the like. In some exemplary embodiments, a target APP may be installed on the client 102. The target APP can capture search terms for the client 102.

The server 103 may be a server that provides various services, such as a backend server that provides support for user data sets and account login information corresponding to a plurality of accounts collected on the client 102, and support for attribute data that effectively describes target objects corresponding to the plurality of accounts.

In some exemplary embodiments, the method for determining attribute data that effectively describes a target object according to the present disclosure may be performed on the server 103. In this case, the server 103 may store data or instructions for performing the method for determining attribute data that effectively describes a target object as described in this disclosure, and may execute or may be configured to execute the data or instructions.

In some exemplary embodiments, the server 103 may include a hardware device with a data information processing function and a necessary program required to drive the hardware device to work. Similarly, the server 103 may be communicatively connected to one client 103, and receive data sent by the client 103, or may be communicatively connected to a plurality of clients 103, and receive data sent by each client 103.

The network 104 is a medium for providing a communication connection between the client 102 and the server 103. The network 104 can facilitate exchange of information or data. As shown in FIG. 1, the client 102 and the server 103 may be connected to the network 104 respectively, and transmit information or data to each other through the network 104.

In some exemplary embodiments, the network 104 may be any type of wired or wireless network, or a combination thereof. For example, the network 104 may include a cable network, a wired network, an optical fiber network, a telecommunication network, an intranet, the Internet, a local area network (Local Area Network, LAN), a wide area network (Wide Area Network, WAN), a wireless local area network (Wireless Local Area Network, WLAN), a metropolitan area network (Metropolitan Area Network, MAN), a public switched telephone network (Public Switched Telephone Network, PSTN), a Bluetooth network™, a short-range wireless network (ZigBee™), a near field communication (Near Field Communication, NFC) network, or a similar network.

In some exemplary embodiments, the network 104 may include one or more network access points. For example, the network 104 may include a wired or wireless network access point, such as a base station or an Internet exchange point, through which one or more components of the client 102 and the server 103 may connect to the network 104 to exchange data or information.

It should be understood that quantities of clients 102, servers 103, and networks 104 in FIG. 1 are merely illustrative. Depending on implementation requirements, there may be any quantities of clients 102, servers 103, and networks 104. In addition, the method for determining attribute data that effectively describes a target object according to the present disclosure may be performed entirely on the client 102, or may be performed entirely on the server 103, or may be performed partially on the client 102 and partially on the server 103.

In other words, FIG. 1 and the foregoing description of FIG. 1 are only used to exemplarily describe application scenarios to which the method for determining attribute data that effectively describes a target object in the present disclosure may be applicable, and cannot be understood as a limitation on the application scenarios.

FIG. 2 is a schematic diagram of a method for determining attribute data that effectively describes a target object according to some exemplary embodiments of the present disclosure. As shown in FIG. 2, the method includes the following steps.

S201: Obtain a descriptor set that describes attributes of a target object, where the descriptor set includes K descriptors, and K is an integer greater than 1.

Exemplarily, this embodiment may be performed by an apparatus for determining attribute data that effectively describes a target object (hereinafter referred to as the determining apparatus). The determining apparatus may be a server, a terminal device, a processor, a chip, or the like, which is not exhaustively listed herein.

If the determining apparatus is a server, the determining apparatus may be a standalone server, a cluster server, a cloud server, or a local server, which is not limited in this embodiment.

Exemplarily, with reference to the application scenario shown in FIG. 1, the determining apparatus may be a client, a server, or a system including a client and a server.

A manner of obtaining the descriptor set is not limited herein.

In an example, the determining apparatus may be connected to another apparatus and receive a descriptor set sent by the other apparatus.

Exemplarily, using the application scenario shown in FIG. 1 as an example, the determining apparatus may be the server shown in FIG. 1, and the other apparatus may be the client shown in FIG. 1. A user may input the descriptor set on the client by using an APP or by non-APP means to trigger the client to send the descriptor set to the server.

In another example, the determining apparatus may provide a descriptor set loading tool, and the user may transmit the descriptor set to the determining apparatus by using the descriptor set loading tool.

The descriptor set loading tool may be an interface for connecting to an external device, for example, an interface for connecting to another storage device, and the descriptor set transmitted by the external device is obtained through the interface. Alternatively, the descriptor set loading tool may be a display apparatus. For example, the determining apparatus may input, to the display apparatus, a function interface for loading the descriptor set, the user may import the descriptor set into the determining apparatus through the interface, and the determining apparatus obtains the imported descriptor set.

S202: Perform a plurality of dimensionality reduction iterations on the descriptor set to reduce a quantity of descriptors in the descriptor set, until the plurality of dimensionality reduction iterations meet preset stop information, where the preset stop information includes a valid quantity value N that enables accuracy of the plurality of dimensionality reduction iterations to reach a first preset value while the quantity of descriptors in the descriptor set remains approximately unchanged, the accuracy is used to represent consistency between a predicted value and a real value of a preset target model, and N is an integer greater than 1.

The dimensionality reduction iteration may be understood as: the determining apparatus reduces the quantity of descriptors in the descriptor set to test impact of a reduced quantity of descriptors on consistency between a predicted value and a real value of the target model, and continuously repeats the test operation. Correspondingly, the preset stop information may be understood as: the determining apparatus continuously performs test operations until the determining apparatus determines, during a test operation, that a reduced quantity of descriptors enables consistency between a predicted value and a real value of the target model to meet a requirement (that is, the consistency is relatively high), and that after the quantity is reduced, a remaining quantity of descriptors in the descriptor set remains basically unchanged while the requirement in a consistency dimension is met.

In other words, N is the remaining quantity of descriptors in the descriptor set, which is a remaining quantity of descriptors that enables the consistency between the predicted value and the real value of the target model to meet the requirement while the quantity of descriptors in the descriptor set no longer decreases. The quantity N may be referred to as a valid quantity value N.

A magnitude of the first preset value is not limited in this embodiment, and may be specifically determined by the determining apparatus based on a requirement, a historical record, an experiment, or the like. For example, in a scenario in which a reliability requirement is relatively high, the determining apparatus may set the first preset value to a relatively large value; or conversely, in a scenario in which a reliability requirement is relatively low, the determining apparatus may set the first preset value to a relatively small value.

In some exemplary embodiments, S202 may include: performing the plurality of dimensionality reduction iterations on the descriptor set by using a genetic algorithm, to reduce the quantity of descriptors in the descriptor set, until the plurality of dimensionality reduction iterations meet the preset stop information.

In other words, in a possible technical solution, the determining apparatus may perform the plurality of dimensionality reduction iterations by using a combination of the genetic algorithm and a network model.

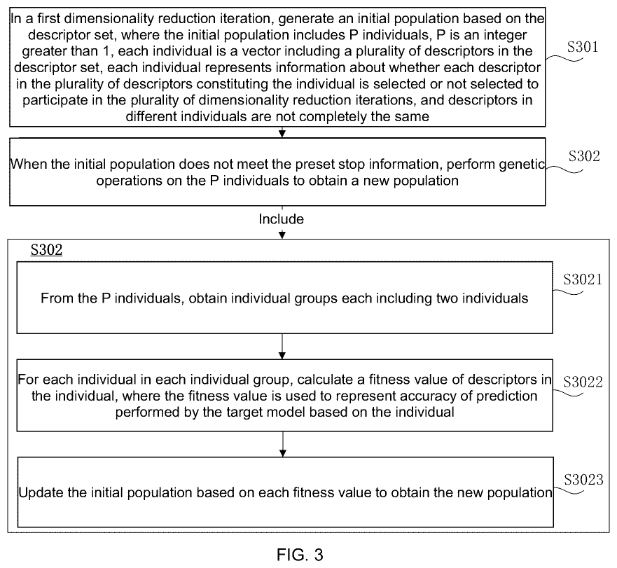

Exemplarily, with reference to FIG. 3, it can be learned that the performing of the plurality of dimensionality reduction iterations on the descriptor set by the determining apparatus by using the genetic algorithm, to reduce the quantity of descriptors in the descriptor set, until the plurality of dimensionality reduction iterations meet the preset stop information may include the following steps.

S301: In a first dimensionality reduction iteration, generate an initial population based on the descriptor set, where the initial population includes P individuals, P is an integer greater than 1, each individual is a vector including a plurality of descriptors in the descriptor set, each individual represents information about whether each descriptor in the plurality of descriptors constituting the individual is selected or not selected to participate in the plurality of dimensionality reduction iterations, and descriptors in different individuals are not completely the same.

Exemplarily, the descriptor set includes 909 descriptors. In the first dimensionality reduction iteration, the determining apparatus generates the initial population based on the 909 descriptors. The initial population includes a plurality of individuals, such as one thousand individuals, where one individual is one vector, that is, the initial population includes one thousand vectors, and for each of the one thousand vectors, the vector includes information about whether a plurality of descriptors participate in the first dimensionality reduction iteration. For example, in the vector, descriptors selected to participate in the first dimensionality reduction iteration are represented by 1, and descriptors not selected are represented by 0.

S302: When the initial population does not meet the preset stop information, perform genetic operations on the P individuals to obtain a new population.

Exemplarily, the initial population is input into the target model as input data of the target model, and the target model predicts a target descriptor value of the target object based on the initial population to obtain a predicted descriptor value. When the determining apparatus determines, based on the predicted descriptor value, that the initial population does not meet the preset stop information, the determining apparatus performs the genetic operations on the initial population to obtain the new population.

In some exemplary embodiments, with reference to FIG. 3, it can be learned that S302 may include the following steps:

S3021: From the P individuals, obtain individual groups each including two individuals.

In other words, the determining apparatus constructs a plurality of individual groups based on the initial population, where one individual group includes two individuals, that is, one individual group includes two vectors.

S3022: For each individual in each individual group, calculate a fitness value of descriptors in the individual, where the fitness value is used to represent accuracy of prediction performed by the target model based on the individual.

Similarly, for each individual, the determining apparatus may use the individual as input data of the target model, the determining apparatus runs the target model, the target model determines a predicted value based on the individual, and the determining apparatus calculates the fitness value of the descriptors in the individual based on a difference between the predicted value and a real value.

S3023: Update the initial population based on each fitness value to obtain the new population.

In some exemplary embodiments, S3023 may include: performing crossover and/or mutation on an individual with a large fitness value in each individual group to update the initial population and obtain the new population. The mutation means adjusting, for at least one individual with a large fitness value in each individual group, a status of at least one descriptor participating in the plurality of dimensionality reduction iterations, in the at least one individual. The crossover means swapping, for two individuals with large fitness values in each individual group, descriptors at any positions in the two individuals.

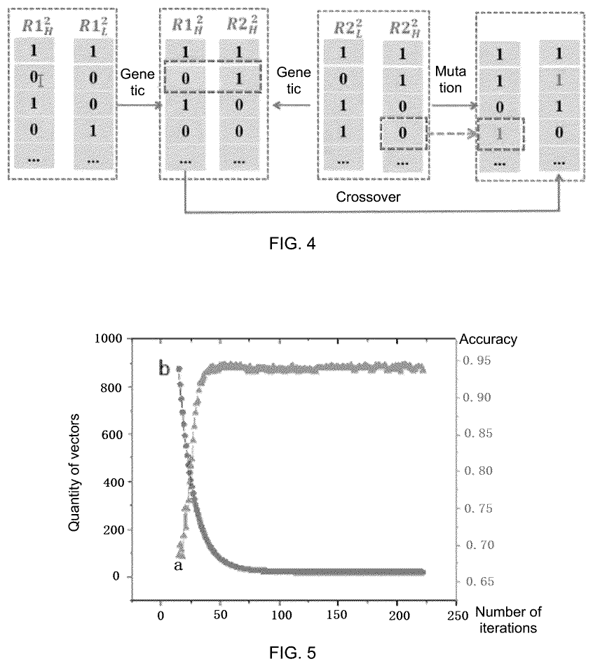

Exemplarily, as shown in FIG. 4, the determining apparatus generates a plurality of (for example, one thousand) vectors based on the 909 descriptors. In any vector, a descriptor selected to participate in the genetic algorithm is represented by 1, and a descriptor not selected is represented by 0. When the determining apparatus runs the genetic algorithm (such as “Genetic” shown in FIG. 4), the determining apparatus may first randomly input two vectors (such as “R1_{H}²” and “R1_{L}²” shown in FIG. 4) into the target model to obtain prediction effects (that is, fitness values) corresponding to the two vectors, and select a vector (such as “R1_{H}²” shown in FIG. 4) with a relatively good prediction effect from the two vectors; then randomly input two vectors (such as “R2_{H}²” and “R2_{L}²” shown in FIG. 4) that are not duplicate with the previous selection into the target model to obtain a vector (such as “R2_{H}²” shown in FIG. 4) with a relatively good prediction effect; then perform crossover and mutation operations (such as “crossover” and “mutation” shown in FIG. 4) on the vector R1_{H}² and the vector R2_{H}² to obtain vectors after the crossover and mutation; and then input the mutated vectors and randomly selected non-duplicate vectors into the target model to obtain a vector with a relatively good prediction effect.

As shown in FIG. 4, the determining apparatus may perform a mutation operation on the vector R2_{H}², for example, mutate a fourth value in the vector R2_{H}² from 0 to 1. The determining apparatus may also perform a crossover operation on R1_{H}² based on the vector R2_{H}², for example, change a second value in the vector R1_{H}² from 0 to 1 to be the same as a second value in the vector R2H2.

It should be noted that when the determining apparatus performs the crossover and mutation operations, the determining apparatus may select one value in the vector or select a plurality of values to implement the operation. In the foregoing example, only one value is used as an example for description, but this cannot be understood as a limitation on the crossover and mutation operations in this embodiment.

The foregoing example illustrates, from the two aspects of crossover and mutation, the determining of the new population by the determining apparatus. In other embodiments, the determining apparatus may determine the new population only from the dimension of crossover, or the determining apparatus may determine the new population only from the dimension of mutation. For an implementation principle thereof, refer to the foregoing example. Details are not described herein.

It should be noted that because the fitness value is positively correlated with prediction performance of the target model, that is, an individual with a large fitness value can more effectively affect the prediction performance of the target model, the determining apparatus performs crossover and/or mutation based on the large fitness value to obtain the new population. This can improve determination of a target population that can more effectively affect the prediction performance of the target model, that is, efficiency of determining the target population can be improved by determining reliability of the new population.

S303: Perform a second dimensionality reduction iteration based on the new population, until a target population that enables the plurality of dimensionality reduction iterations to meet the preset stop information is obtained.

Correspondingly, with reference to the foregoing example, when the determining apparatus obtains the new population, the determining apparatus performs the second dimensionality reduction iteration based on the new population, and so on, until the determining apparatus obtains a population (that is, the target population) that meets the preset stop information.

S203: Determine, from descriptors obtained by the plurality of dimensionality reduction iterations, descriptors whose occurrence frequencies meet a preset condition as core descriptors.

Exemplarily, the determining apparatus performs the dimensionality reduction iterations on the descriptor set in a manner of continuously reducing the quantity of descriptors in the descriptor set. Therefore, the quantity of descriptors used by the determining apparatus in each dimensionality reduction iteration is different, that is, the descriptors used in each dimensionality reduction iteration are different.

Correspondingly, in this step, the determining apparatus determines, based on an occurrence frequency of each of the descriptors used in each dimensionality reduction iteration, the descriptors whose occurrence frequencies meet the preset condition, and determines the descriptors corresponding to the occurrence frequencies that meet the preset condition as the core descriptors.

In other words, an occurrence frequency of a descriptor is a frequency of occurrence of the descriptor in the plurality of dimensionality reduction iterations. Relatively, the more frequently the descriptor appears in the plurality of dimensionality reduction iterations, the greater the impact of the descriptor on the performance of the target model (such as the accuracy in the foregoing example, that is, the consistency between the predicted value and the real value of the target model). Therefore, the core descriptor can be understood as a descriptor that has greater impact on the performance of the target model, in the descriptor set.

In some exemplary embodiments, the preset condition is that a difference between a minimum occurrence frequency of a descriptor among the core descriptors and a maximum occurrence frequency of a descriptor among other descriptors is greater than a preset difference threshold.

Exemplarily, based on impact of the descriptors on the performance of the target model, the descriptors may be classified into core descriptors and non-core descriptors (the other descriptors), and each descriptor has its corresponding occurrence frequency. In other words, each core descriptor has its corresponding occurrence frequency, and there is a minimum occurrence frequency (that is, the minimum occurrence frequency) among the occurrence frequencies. Similarly, each non-core descriptor also has its corresponding occurrence frequency, and there is a maximum occurrence frequency (that is, the maximum occurrence frequency) among the occurrence frequencies. The preset condition is that the difference between the minimum occurrence frequency and the maximum occurrence frequency is large (for example, greater than the preset difference threshold).

Similarly, a magnitude of the preset difference threshold is not limited in this embodiment, and may be determined by the determining apparatus based on a requirement, a historical record, an experiment, or the like.

In this embodiment, the determining apparatus determines the preset condition with reference to the occurrence frequencies and the preset difference threshold, to determine the core descriptors based on the preset condition, thereby achieving accuracy in screening the descriptors in the descriptor set, so that the core descriptors obtained through screening can improve the efficiency of training the target model and that a target model with relatively high reliability can be obtained.

In some exemplary embodiments, the target model is an artificial intelligence model that predicts the target descriptor value for the target object based on the core descriptors and N. The target object is a target material, and the descriptors in the descriptor set are known descriptors of the target material. The dimensionality reduction iterations are iterations for the target model.

Exemplarily, the target object may be the target material, the target descriptor value may be electrical conductivity of the target material, and the artificial intelligence model may be an artificial intelligence model that uses descriptors determined based on the core descriptors and N as input data and uses the electrical conductivity as an output.

The input data includes the core descriptors, and further includes non-core descriptors selected from the non-core descriptors based on N and the quantity of core descriptors. For example, a sum of a quantity of non-core descriptors and the quantity of core descriptors in the input data is N, that is, the quantity of non-core descriptors in the input data is N minus the quantity of core descriptors, and the non-core descriptors in the input data are any descriptors among the non-core descriptors.

A structure, type, and the like of the artificial intelligence model are not limited in this embodiment. For example, the artificial intelligence model may be a network structure including a CNN and an ANN.

With reference to the foregoing example, the dimensionality reduction iterations may be operations performed by the determining apparatus on the artificial intelligence model, and dimensionality reduction may be specifically understood as reduction of the quantity of descriptors in the descriptor set, and training of the artificial intelligence model based on the descriptor set after dimensionality reduction. The entire process is an iteration process, that is, a process of continuous loop execution until the loop process meets the preset stop information.

For example, in an i^{th} dimensionality reduction iteration, the determining apparatus reduces the quantity of descriptors on a basis of descriptor set i−1 to obtain descriptor set i, and uses descriptor set i as an input of artificial intelligence model i−1 to train a prediction capability of a target descriptor value of the artificial intelligence model to obtain artificial intelligence model i, and when the i^{th} dimensionality reduction iteration does not meet the preset stop information, the determining apparatus performs an (i+1)^{th} dimensionality reduction iteration. Similarly, in the (i+1)^{th} dimensionality reduction iteration, the determining apparatus reduces the quantity of descriptors on a basis of descriptor set i to obtain descriptor set i+1, and uses descriptor set i+1 as an input of artificial intelligence model i to train a prediction capability of a target descriptor value of the artificial intelligence model to obtain artificial intelligence model i+1, and when the (i+1)^{th} dimensionality reduction iteration does not meet the preset stop information, the determining apparatus performs an (i+2)^{th} dimensionality reduction iteration, and so on, until the preset stop information is met in an (i+k)^{th} dimensionality reduction iteration, where i and k are both integers greater than 1.

Correspondingly, with reference to FIG. 5, a horizontal coordinate is the number of dimensionality reduction iterations (“number” shown in FIG. 5), and a vertical coordinate includes content in two dimensions, where content in one dimension is a quantity of vectors generated based on the initial population, which may be one thousand shown in FIG. 5, and content in the other dimension is accuracy of a prediction result. FIG. 5 includes two curves, where one curve is a curve of descriptor dimensions (“b” shown in FIG. 5), and the other curve is a curve of accuracy (“a” shown in FIG. 5).

From FIG. 5, it can be learned that in a scenario in which the determining apparatus performs dimensionality reduction iterations based on the genetic algorithm, as the number of dimensionality reduction iterations increases, when the number of dimensionality reduction iterations reaches a threshold (approximately 50 shown in FIG. 5), the accuracy and the quantity of descriptors remain basically unchanged. For example, the accuracy remains approximately 0.95, and the quantity of descriptors remains approximately 20.

Therefore, the valid quantity value N may be understood as the quantity of descriptors in the dimensionality reduction iterations when descriptor dimensions are basically stable and no longer decrease, and the accuracy is also basically stable and does not decrease. The core descriptor may be determined based on a statistical frequency of each descriptor participating in the dimensionality reduction iterations. For example, the determining apparatus determines the occurrence frequency of each descriptor participating in the dimensionality reduction iterations, that is, the number of times the descriptor appears in the dimensionality reduction iterations, and determines a plurality of descriptors with high occurrence frequencies from all occurrence frequencies as core descriptors. For example, top L descriptors with the highest occurrence frequency are used as core descriptors, and a difference between the minimum occurrence frequency in the core descriptors and the maximum occurrence frequency in the non-core descriptors is large. For example, there is a cliff-like drop of the occurrence frequenc of each descriptor due to the difference between the minimum occurrence frequency and the maximum occurrence frequency.

In some exemplary embodiments, with reference to FIG. 2, it can be learned that S203 may include the following steps.

S2031: Calculate an occurrence frequency of each descriptor in the population participating in the plurality of dimensionality reduction iterations.

Exemplarily, there is a correspondence between a population and a dimensionality reduction iteration, that is, populations used by the determining apparatus in different dimensionality reduction iterations are different, and descriptors included in different populations are at least partially different. Therefore, the number of times different descriptors participate in the dimensionality reduction iterations may vary. For example, some descriptors may participate in more dimensionality reduction iterations, while some descriptors may participate in fewer dimensionality reduction iterations. In this step, the determining apparatus calculates participation frequencies (that is, the occurrence frequencies) of the descriptors participating in the dimensionality reduction iterations.

S2032: Determine the core descriptor based on each occurrence frequency.

The occurrence frequency of each descriptor represents how often each descriptor participates in the dimensionality reduction iterations. Therefore, on this basis, the determining apparatus can determine the core descriptor based on a corresponding participation frequency of each descriptor.

In some exemplary embodiments, S2032 may include the following steps.

Step 1: Sort the occurrence frequencies in descending order.

Step 2: In the descending order, when a difference between two adjacent occurrence frequencies is greater than a preset difference threshold for a first time, determine descriptors from a first occurrence frequency to a second occurrence frequency in the descending order as the core descriptors, where the second occurrence frequency is a higher occurrence frequency in the two adjacent occurrence frequencies.

Exemplarily, the determining apparatus sorts the occurrence frequencies from high to low to obtain the descending order of the occurrence frequencies. The determining apparatus may compare adjacent occurrence frequencies in the descending order sequentially to determine whether a difference between adjacent occurrence frequencies is greater than the preset difference threshold. If yes, it indicates that the difference between two adjacent occurrence frequencies is large. In this case, the determining apparatus may determine a descriptor with the first occurrence frequency in the descending order until a descriptor with a lower occurrence frequency in the adjacent occurrence frequencies as the core descriptors.

For example, the descending order includes occurrence frequency F1, occurrence frequency F2, . . . , occurrence frequency Fa. The determining apparatus determines whether a difference between occurrence frequency F1 and occurrence frequency F2 is greater than the preset difference threshold. If yes, a descriptor with occurrence frequency F1 and a descriptor with occurrence frequency F2 are determined as core descriptors. Otherwise, the determining apparatus continues to determine whether a difference between occurrence frequency F2 and occurrence frequency F3 is greater than the preset difference threshold. If yes, the descriptor with occurrence frequency F2 and a descriptor with occurrence frequency F3 are determined as core descriptors. Otherwise, the determining apparatus continues to determine whether a difference between occurrence frequency F3 and occurrence frequency F4 is greater than the preset difference threshold, and so on. Details are not exhaustively illustrated herein.

With reference to the description of the preset condition in the foregoing example, it can be learned that the second occurrence frequency in this embodiment is the minimum occurrence frequency in the preset condition, and that the maximum occurrence frequency in the preset condition is a lower occurrence frequency in the two adjacent occurrence frequencies.

In this embodiment, the determining apparatus determines the core descriptors through sorting, and therefore can quickly locate two adjacent occurrence frequencies with a great change (that is, greater than the preset difference threshold) in the occurrence frequencies, thereby quickly determining the core descriptors, that is, improving efficiency of determining the core descriptors.

S204: Output the core descriptors and N as attribute data.

Exemplarily, after the determining apparatus obtains the core descriptors and N, the determining apparatus may output the core descriptors and N to a training apparatus, so that the training apparatus determines the input data of the target model based on the core descriptors and N, and that when a prediction apparatus runs the target model, the target model outputs the target descriptor value of the target object based on the input data.

With reference to the foregoing analysis, N is the valid quantity of descriptors, and the core descriptors are descriptors that affect the performance of the target model. Therefore, at a training stage, the training apparatus determines the input data of the target model based on N and the core descriptors to avoid using a full set of descriptors as the input data of the target model. This can reduce an amount of input data without affecting a prediction effect of the target model.

It should be noted that the foregoing examples are only used to exemplarily describe possible implementations of the method for determining attribute data that effectively describes a target object in the present disclosure, and cannot be understood as limitations on the implementations of the method for determining attribute data that effectively describes a target object in the present disclosure. Exemplarily, based on the foregoing technical conception, some of the foregoing technical features may be combined to obtain a new embodiment; new technical features may be added based on the foregoing examples to obtain a new embodiment; some technical features may be removed based on the foregoing examples to obtain a new embodiment; some technical features in the foregoing examples may be replaced with other technical features; some technical features and an order thereof in the foregoing examples may be adjusted to obtain a new embodiment, and so on. Details are not exhaustively illustrated herein.

Based on the foregoing technical conception, the present disclosure further provides a processor-readable storage medium. The processor-readable storage medium stores a computer program. The computer program is configured to enable a processor to perform the method for determining attribute data that effectively describes a target object according to any one of the foregoing embodiments.

Based on the foregoing technical conception, the present disclosure further provides a computer program product, including a computer program. When executed by a processor, the computer program implements the method for determining attribute data that effectively describes a target object according to any one of the foregoing embodiments.

Based on the foregoing technical conception, the present disclosure further provides a system for determining attribute data that effectively describes a target object. The system includes:
at least one memory, where the memory includes at least one set of instructions to push information; and
at least one processor, communicating with the at least one memory, where
when the at least one processor executes the at least one set of instructions, the method for determining attribute data that effectively describes a target object according to any one of the foregoing embodiments is implemented.

Based on the foregoing technical conception, the present disclosure further provides an electronic device, including a processor and a memory communicatively connected to the processor.

The memory stores computer-executable instructions.

The processor executes the computer-executable instructions stored in the memory to implement the method for determining attribute data that effectively describes a target object according to any one of the foregoing embodiments.

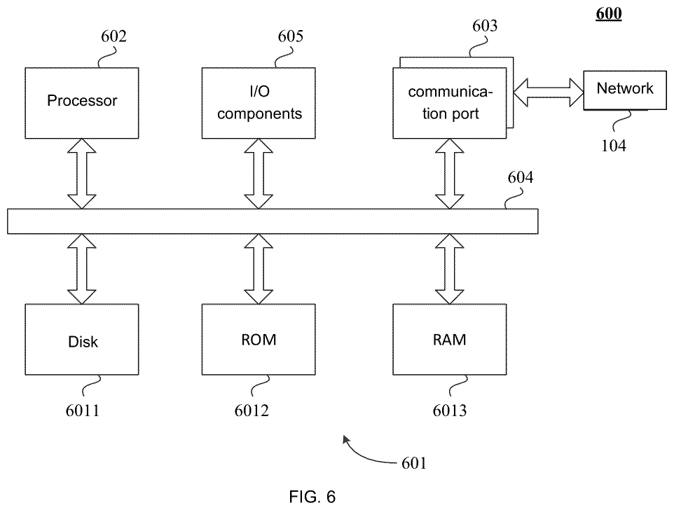

FIG. 6 is a diagram of a hardware structure of an electronic device 600 according to some exemplary embodiments of the present disclosure. The electronic device 600 may perform the method for determining attribute data that effectively describes a target object according to any one of the foregoing embodiments.

Assuming that the method for determining attribute data that effectively describes a target object in the embodiments of the present disclosure is applied to the application scenario shown in FIG. 1, the electronic device 600 is described as follows:

When the method for determining attribute data that effectively describes a target object according to any one of the foregoing embodiments is performed on the client 102, the electronic device 600 may be the client 102. When the method for determining attribute data that effectively describes a target object according to any one of the foregoing embodiments is performed on the server 103, the electronic device 600 may be the server 103. When the method for determining attribute data that effectively describes a target object according to any one of the foregoing embodiments is partially performed on the client 102 and partially performed on the server 103, the electronic device 600 may be the client 102 and the server 103.

As shown in FIG. 6, the electronic device 600 may include at least one storage medium 601 and at least one processor 602. In some exemplary embodiments, the electronic device 600 may further include a communication port 603 and an internal communication bus 604. In addition, the electronic device 600 may further include an input/output (Input/Output, I/O) component 605.

The internal communication bus 604 may connect different system components, including the storage medium 601, the processor 602, and the communication port 603. The I/O component 605 supports inputting/outputting between the electronic device 600 and another component. The communication port 603 is used for data communication between the electronic device 600 and the outside world. For example, the communication port 603 may be used for data communication between the electronic device 600 and the network 104. The communication port 603 may be a wired communication port or a wireless communication port.

The storage medium 601 may include a data storage apparatus. The data storage apparatus may be a non-transitory storage medium, or may be a transitory storage medium. For example, the data storage apparatus may include one or more of a magnetic disk 6011, a read-only storage memory (Read-Only Memory, ROM) 6012, or a random access memory (Random Access Memory, RAM) 6013. The storage medium 601 further includes at least one instruction set stored in the data storage apparatus. The instruction set may be computer program code, where the computer program code may include a program, a routine, an object, a component, a data structure, a process, a module, or the like for performing the method for determining attribute data that effectively describes a target object according to this disclosure.

The at least one processor 602 may be communicatively connected to the at least one storage medium 601 and the communication port 603 by using the internal communication bus 604. The at least one processor 602 is configured to execute the at least one instruction set. When the electronic device 600 is running, the at least one processor 602 reads the at least one instruction set, and performs, as instructed by the at least one instruction set, the method for determining attribute data that effectively describes a target object according to this disclosure. The processor 602 may perform all the steps included in the method for determining attribute data that effectively describes a target object. The processor 602 may be in a form of one or more processors. In some exemplary embodiments, the processor 602 may include one or more hardware processors, such as a microcontroller, a microprocessor, a reduced instruction set computer (Reduced Instruction Set Computer, RISC), an application specific integrated circuit (Application Specific Integrated Circuit, ASIC), an application specific instruction processor (Application Specific Instruction Processor, ASIP), a central processing unit (Central Processing Unit, CPU), a graphics processing unit (Graphics Processing Unit, GPU), a physics processing unit (Physics Processing Unit, PPU), a microcontroller unit, a digital signal processor (Digital Signal Processor, DSP), a field programmable gate array (Field Programmable Gate Array, FPGA), an advanced RISC machine (ARM), a programmable logic device (Programmable Logic Device, PLD), any circuit or processor capable of performing one or more functions, or the like, or any combination thereof. For illustration purposes only, only one processor 602 in the electronic device 600 is described in this disclosure. However, it should be noted that the electronic device 600 in this disclosure may further include a plurality of processors. Therefore, operations and/or method steps disclosed in this disclosure may be performed by one processor in this disclosure, or may be performed jointly by a plurality of processors. For example, if the processor 602 of the electronic device 600 in this disclosure performs step A and step B, it should be understood that step A and step B may also be performed jointly or separately by two different processors 602 (for example, the first processor performs step A, and the second processor performs step B, or the first processor and the second processor jointly perform step A and step B).

A person skilled in the art will understand that the embodiments of this disclosure can be provided as a method, a system, or a computer program product. Therefore, this disclosure can be implemented as a fully hardware embodiment, a fully software embodiment, or an embodiment combining software and hardware aspects. Moreover, this disclosure can be implemented as a computer program product on one or more computer-usable storage media containing computer-usable program code (including but not limited to disk storage, optical storage, etc.).

This disclosure is described with reference to flowcharts and/or block diagrams of methods, devices (systems), and computer program products according to the embodiments of this disclosure. It should be understood that each flow and/or block in the flowcharts and/or block diagrams, and the combinations of flows and/or blocks in the flowcharts and/or block diagrams, can be implemented by computer-executable instructions. These computer-executable instructions can be provided to a processor of a general-purpose computer, a special-purpose computer, an embedded processor, or another programmable data processing device to produce a machine that, when the instructions are executed by a computer or other programmable data processing device, produces a device that performs the functions specified in one or more flows of the flowcharts or one or more blocks of the block diagrams.

These processor-executable instructions may also be stored in a processor-readable memory that can direct a computer or other programmable data processing device to function in a particular way, such that the instructions stored in the processor-readable memory produce an article of manufacture including instruction means that implement the functions specified in one or more flows of the flowcharts or one or more blocks of the block diagrams.

These processor-executable instructions may also be loaded onto a computer or other programmable data processing device to cause a series of operational steps to be performed on the computer or other programmable device to produce a computer-implemented process such that the instructions executed on the computer or other programmable device provide steps for implementing the functions specified in one or more flows of the flowcharts or one or more blocks of the block diagrams.

Apparently, a person skilled in the art can make various modifications and variations to this disclosure without departing from the spirit and scope of the disclosure. Accordingly, if such modifications and variations of this disclosure fall within the scope of the claims of this disclosure and their equivalents, this disclosure is intended to cover these modifications and variations.

What is claimed is:

1. A method for determining attribute data that effectively describes a target object, comprising:
obtaining a descriptor set describing attributes of a target object, wherein the descriptor set includes K descriptors;
performing a plurality of dimensionality reduction iterations on the descriptor set to reduce a quantity of descriptors in the descriptor set, until the plurality of dimensionality reduction iterations meet preset stop information, wherein the preset stop information includes a valid quantity value N that enables accuracy of the plurality of dimensionality reduction iterations to reach a first preset value while the quantity of descriptors in the descriptor set remains approximately unchanged, the accuracy is used to represent consistency between a predicted value and a real value of a preset target model, and K and N are both integers greater than 1;
determining, from descriptors obtained by the plurality of dimensionality reduction iterations, descriptors whose occurrence frequencies meet a preset condition as core descriptors; and
outputting the core descriptors and N as attribute data.

2. The method according to claim 1, wherein the preset condition is that a difference between a minimum occurrence frequency of a descriptor among the core descriptors and a maximum occurrence frequency of a descriptor among remaining descriptors is greater than a preset difference threshold.

3. The method according to claim 1, wherein the target model is an artificial intelligence model that predicts a target descriptor value of the target object based on the core descriptors and N;
the target object is a target material, and the descriptors in the descriptor set are known descriptors of the target material; and
the dimensionality reduction iterations are iterations for the target model.

4. The method according to claim 3, wherein the target descriptor value includes electrical conductivity of the target material.

5. The method according to claim 1, wherein the performing of the plurality of dimensionality reduction iterations on the descriptor set to reduce the quantity of descriptors in the descriptor set, until the plurality of dimensionality reduction iterations meet the preset stop information includes:
performing the plurality of dimensionality reduction iterations on the descriptor set by using a genetic algorithm, to reduce the quantity of descriptors in the descriptor set, until the plurality of dimensionality reduction iterations meet the preset stop information.

6. The method according to claim 5, wherein the performing of the plurality of dimensionality reduction iterations on the descriptor set by using the genetic algorithm, to reduce the quantity of descriptors in the descriptor set, until the plurality of dimensionality reduction iterations meet the preset stop information includes:
in a first dimensionality reduction iteration, generating an initial population based on the descriptor set, wherein the initial population includes P individuals, P is an integer greater than 1, each individual is a vector comprising a plurality of descriptors in the descriptor set, each individual represents information about whether each descriptor in the plurality of descriptors constituting the individual is selected or not selected to participate in the plurality of dimensionality reduction iterations, and descriptors in different individuals are not completely the same; and
when the initial population does not meet the preset stop information, performing genetic operations on the P individuals to obtain a new population, and performing a second dimensionality reduction iteration based on the new population, until a target population that enables the plurality of dimensionality reduction iterations to meet the preset stop information is obtained.

7. The method according to claim 6, wherein the performing of the genetic operations on the P individuals to obtain the new population includes:
obtaining, from the P individuals, individual groups each comprising two individuals;
for each individual in each individual group, calculating a fitness value of descriptors in the individual, wherein the fitness value is used to represent accuracy of prediction performed by the target model based on the individual; and
updating the initial population based on each fitness value to obtain the new population.

8. The method according to claim 7, wherein the updating of the initial population based on each fitness value to obtain the new population includes:
performing at least one of crossover or mutation on an individual with a large fitness value in each individual group to update the initial population and obtain the new population, wherein
the mutation means adjusting, for at least one individual with a large fitness value in each individual group, a status of at least one descriptor participating in the plurality of dimensionality reduction iterations, in the at least one individual, and
the crossover means swapping, for two individuals with large fitness values in each individual group, descriptors at any positions in the two individuals.

9. The method according to claim 1, wherein the determining, from descriptors obtained by the plurality of dimensionality reduction iterations, the descriptors whose occurrence frequencies meet the preset condition as the core descriptors includes:
calculating an occurrence frequency of each descriptor in the population participating in the plurality of dimensionality reduction iterations; and
determining the core descriptor based on each occurrence frequency.

10. The method according to claim 9, wherein the determining of the core descriptor based on each occurrence frequency includes:
sorting the occurrence frequencies in descending order; and
in the descending order, when a difference between two adjacent occurrence frequencies is greater than a preset difference threshold for a first time, determining descriptors from a first occurrence frequency to a second occurrence frequency in the descending order as the core descriptors, wherein
the second occurrence frequency is a higher occurrence frequency in the two adjacent occurrence frequencies.

11. A system for determining attribute data that effectively describes a target object, comprising:
at least one memory, wherein the memory includes at least one set of instructions to push information; and
at least one processor, communicating with the at least one memory, wherein during operation, the at least one processor executes the at least one set of instructions to cause the system to at least:
obtain a descriptor set describing attributes of a target object, wherein the descriptor set includes K descriptors,
perform a plurality of dimensionality reduction iterations on the descriptor set to reduce a quantity of descriptors in the descriptor set, until the plurality of dimensionality reduction iterations meet preset stop information, wherein the preset stop information includes a valid quantity value N that enables accuracy of the plurality of dimensionality reduction iterations to reach a first preset value while the quantity of descriptors in the descriptor set remains approximately unchanged, the accuracy is used to represent consistency between a predicted value and a real value of a preset target model, and K and N are both integers greater than 1,
determine, from descriptors obtained by the plurality of dimensionality reduction iterations, descriptors whose occurrence frequencies meet a preset condition as core descriptors, and
output the core descriptors and N as attribute data.

12. The system according to claim 11, wherein the preset condition is that a difference between a minimum occurrence frequency of a descriptor among the core descriptors and a maximum occurrence frequency of a descriptor among remaining descriptors is greater than a preset difference threshold.

13. The system according to claim 11, wherein the target model is an artificial intelligence model that predicts a target descriptor value of the target object based on the core descriptors and N;
the target object is a target material, and the descriptors in the descriptor set are known descriptors of the target material; and
the dimensionality reduction iterations are iterations for the target model.

14. The system according to claim 13, wherein the target descriptor value includes electrical conductivity of the target material.

15. The system according to claim 11, wherein to perform the plurality of dimensionality reduction iterations on the descriptor set to reduce the quantity of descriptors in the descriptor set, until the plurality of dimensionality reduction iterations meet the preset stop information, the at least one processor executes the at least one set of instructions to cause the system to at least:
perform the plurality of dimensionality reduction iterations on the descriptor set by using a genetic algorithm, to reduce the quantity of descriptors in the descriptor set, until the plurality of dimensionality reduction iterations meet the preset stop information.

16. The system according to claim 15, wherein to perform the plurality of dimensionality reduction iterations on the descriptor set by using the genetic algorithm, to reduce the quantity of descriptors in the descriptor set, until the plurality of dimensionality reduction iterations meet the preset stop information, the at least one processor executes the at least one set of instructions to cause the system to at least:
in a first dimensionality reduction iteration, generate an initial population based on the descriptor set, wherein the initial population includes P individuals, P is an integer greater than 1, each individual is a vector comprising a plurality of descriptors in the descriptor set, each individual represents information about whether each descriptor in the plurality of descriptors constituting the individual is selected or not selected to participate in the plurality of dimensionality reduction iterations, and descriptors in different individuals are not completely the same; and
when the initial population does not meet the preset stop information, perform genetic operations on the P individuals to obtain a new population, and perform a second dimensionality reduction iteration based on the new population, until a target population that enables the plurality of dimensionality reduction iterations to meet the preset stop information is obtained.

17. The system according to claim 16, wherein to perform the genetic operations on the P individuals to obtain the new population, the at least one processor executes the at least one set of instructions to cause the system to at least:
obtain, from the P individuals, individual groups each comprising two individuals;
for each individual in each individual group, calculate a fitness value of descriptors in the individual, wherein the fitness value is used to represent accuracy of prediction performed by the target model based on the individual; and
update the initial population based on each fitness value to obtain the new population.

18. The system according to claim 17, wherein to update the initial population based on each fitness value to obtain the new population, the at least one processor executes the at least one set of instructions to cause the system to at least:
perform at least one of crossover or mutation on an individual with a large fitness value in each individual group to update the initial population and obtain the new population, wherein
the mutation means adjusting, for at least one individual with a large fitness value in each individual group, a status of at least one descriptor participating in the plurality of dimensionality reduction iterations, in the at least one individual, and
the crossover means swapping, for two individuals with large fitness values in each individual group, descriptors at any positions in the two individuals.

19. The system according to claim 11, wherein to determine, from descriptors obtained by the plurality of dimensionality reduction iterations, the descriptors whose occurrence frequencies meet the preset condition as the core descriptors, the at least one processor executes the at least one set of instructions to cause the system to at least:
calculate an occurrence frequency of each descriptor in the population participating in the plurality of dimensionality reduction iterations; and
determine the core descriptor based on each occurrence frequency.

20. The system according to claim 19, wherein to determine the core descriptor based on each occurrence frequency, the at least one processor executes the at least one set of instructions to cause the system to at least:
sort the occurrence frequencies in descending order; and
in the descending order, when a difference between two adjacent occurrence frequencies is greater than a preset difference threshold for a first time, determine descriptors from a first occurrence frequency to a second occurrence frequency in the descending order as the core descriptors, wherein
the second occurrence frequency is a higher occurrence frequency in the two adjacent occurrence frequencies.
